(19) United States
(12) Patent Application Publication
(10) Pub. No.: US 2021/0368756 A1
(43) Pub. Date: Dec. 2, 2021

(54) BAIT NET CASTING DEVICE FOR CATCHING SEA SPECIES

(71) Applicants: Brett C. Hajek, Flatonia, TX (US); Brandon M. Hajek, Flatonia, TX (US)

(72) Inventors: Brett C. Hajek, Flatonia, TX (US); Brandon M. Hajek, Flatonia, TX (US)

(21) Appl. No.: 17/384,122

(22) Filed: Jul. 23, 2021

Related U.S. Application Data
(63) Continuation-in-part of application No. 29/735,953, filed on May 26, 2020.

(51) Int. Cl. A01K 73/06; A01K 75/06

(52) U.S. Cl. CPC A01K 73/06; A01K 75/06

(57) ABSTRACT

A bait net casting device for catching sea species including a housing having a reel with a retractable cord. The housing includes an opening at the top and forms a handle for holding the bait net casting device when not in use. The bait net casting device includes line strands connecting the cord via connecting rings at one end and a disk at another end. The bait net casting device includes a line coupler drawn through the line strands. The bait net casting device includes a net connecting the disk. The net includes a lead line at its circumference. The lead line includes weights circumferentially spaced in relation to another. A user draws a waist belt through the opening to connect and suspend the housing from the belt. The net casts pulling the cord from the reel. Further, the cord retracts into the housing pulling back and closing the net.

### CROSS-REFERENCE TO RELATED APPLICATIONS

This application claims priority to a U.S. Design patent application No. 29/735,953, titled “BAIT NET CASTING DEVICE DESIGN, with Attorney Docket No. HAJKOOlUSD, filed May 26, 2020, which is hereby incorporated by reference in its entirety.

### FIELD OF INVENTION

The present invention generally relates to catching sea species. More specifically, the present invention relates to a bait net casting device for catching sea species.

### BACKGROUND OF INVENTION

It is known that bait nets or cast nets are commonly used in the fishing industry to catch sea species such as baitfish, shrimp, etc. The bait nets are used by fishermen wading into a body of water, standing on a shore, or from a boat. Conventional bait nets include a net having a round circumference when it is thrown. The net includes a weighted line or lead line disposed at the periphery of the net. The lead line receives weights circumferentially spaced in relation to another at the end. The lead line together with the weights cause the net to sink in the water. Further, the net includes a large number of drawstrings, often called as brails or braille lines. The drawstrings extend diametrically across the net in which one end attach to the lead line and other end attach at the center of the net. The center of net then connects to a rope that the user holds or connects to a variety of devices to cast the net.

The conventional bait nets present several problems. For example, the drawstrings get tangled easily in the net and prevent the net from fully extending during use. Further, if a drawstring breaks, then it takes considerable time to replace the drawstring.

Several attempts have been made in the past to address the above problem. Once such an example is disclosed in a granted U.S. Pat. No. 6,584,724, entitled, “Fish Landing Net Apparatus” (“the '724 patent”). The '724 discloses a fish landing net apparatus for facilitating landing of a fish without losing the net. The fish landing net apparatus includes a housing having a perimeter wall. The perimeter wall defines an interior space. The housing is designed for securing to the user. A reel assembly is positioned within the interior space of the housing. A cable member extends from the housing. The cable member is coupled to the reel assembly whereby the reel assembly is for winding the cable member back into the interior space of the housing when the cable member has been extended from the housing. A landing member is coupled to the cable member opposite the reel assembly. The reel assembly draws the landing member back towards the housing when the user releases the landing member. The landing member is designed for facilitating retrieval of the fish when the user has reeled in the fish.

Another example is disclosed in a United States Publication No. 20050039372, entitled “Cast Net with Elastic Wrist Cuff” (“the '372 Publication”). The '372 Publication discloses a cast net having a circular net portion the circumference of which is defined by a lead line. The cast net having a throw line one end of which is attached to the center of the net portion. The other end of the throw line comprises a flexible cuff which is adapted to be slipped over a human hand and engages a human wrist. The flexible cuff allows the throw line to disengage the human wrist by slipping over the hand. This disengagement can be effected simply and quickly in an emergency situation. The flexible cuff further adds a degree of comfort to the throwing process as it does not bind the wrist of the user.

Yet another example is disclosed in a Japanese Patent Publication No. 2013208070, entitled “Handle with Winding Mechanism and Sweetfish Scooping Net” (“the '070 Publication”). The '070 Publication discloses a tool including a handle serving as a grip for a worker to a working functional part and a winding mechanism fixed to the handle, wherein the winding mechanism is a handle with a winding mechanism, which can draw and take up the string. Further, the tool includes a sheath body having an internal space for storing the handle, wherein the end of the string drawn out from the winding mechanism is fixed to the sheath body. When the tool is a sweetfish scooping net, preferably the sheath body has a mesh structure.

Yet another example is disclosed in a granted U.S. Pat. No. 8,272,158, entitled, “Fishing Net Release Device” (“the '158 patent”). The '158 patent discloses a device that assists in the holding and releasing of a cast net when thrown for fishing. The device replaces the traditional practice of holding the edge of a casting net in a fisherman's mouth while throwing. The device is made of a section of synthetic cord wherein each end of the cord is attached to the outward leg of a clip mechanism, thus forming a loop configuration. The loop is then placed around the fisherman's neck with the clip mechanism hanging in a downward configuration. The cast net is then prepared to throw but instead of placing the edge of the net in the mouth, it is secured within the jaws of the clip. The net is then cast and as the net travels away from the fisherman, it pulls away from the clip resulting in a perfect cast.

Although the above-discussed devices present different ways to overcome the problems associated with the drawstrings, they have few problems. For example, the devices are directly connected to the user or fisherman. As such, they limit the user from throwing the net at a faraway distance. Further, they are difficult to install and uninstall. Furthermore, they are not easy to carry around.

Therefore, there is a need in the art to provide a bait net casting device for catching sea species, the bait net casting device that suspends from the user and is easy to operate.

### SUMMARY

It is an object of the present invention to provide a bait net casting device that avoids the drawback of known devices.

It is another object of the present invention to provide a bait net casting device that connects to a user easily and allows him/her to cast the net.

It is another object of the present invention to provide a bait net casting device that connects to the user's waist belt and includes a retractable cord connecting the net.

It is another object of the present invention to provide a bait net casting device that is free from tangling of ropes and provides an easy way to cast the net.

It is another object of the present invention to provide a bait net casting device that connects to the user around his waist and allows the user to use both hands to throw the net farther and more accurately.

In order to achieve one or more objects, the present invention provides a bait net casting device for catching sea species. The bait net casting device includes a housing having a reel with a retractable tension cord. The housing includes an opening at the top and forms a handle for holding the bait net casting device when not in use.

The housing includes a curved extended section having a hole facing downwards. The cord extends from the housing through the hole. The cord connects to cables via a connector. The cables connect to connecting rings. The connecting rings connect to line strands that connect to a disk. The line strands draw through a line coupler. The disk includes apertures for receiving a net. The net includes a lead line at its circumference. The lead line includes weights circumferentially spaced in relation to another.

A user draws a belt through the opening to connect and suspend the housing from the belt. Alternatively, the user draws any other object through the opening at the housing to connect the housing to any structure. The net casts pulling the cord from the reel. Further, the cord retracts into the housing pulling back and closing the net.

The user stands on a shore, wades into a body of the water or stands on a boat for using the bait net casting device. The user grasps the net along the lead line with one hand and holds the disk with the other hand. The user twists to generate momentum to throw the net into the water. The user rotates in a clockwise or anticlockwise direction such that the motion opens the net wide open in a plane just above and parallel to the surface of water before falling into the water. Here, the cord extends from the reel and increases its length allowing the user to throw the net at a distance from him/her. Upon throwing the net, the weights force the net to fall through the water until the net reaches desired depth. Subsequently, the user pulls the cord towards him/her to harvest the sea species. Pulling the cord causes the cables, the line strands, the line coupler and the net to follow. Here, the cord, the cables, and the line strands act as a throw line in a typical bait net casting device. As the user pulls the cord, the net and/or the weights close, preventing the sea species from escaping the net.

After completion of catching the sea species, the reel causes the cord to retrieve into the housing where the cord winds up the reel due to tension and brings the bait net casting device to its default position.

In one advantageous feature of the present invention, the bait net casting device connects to the user's waist at all times. As such, the bait net casting device cannot be lost while wading in shallow water or in a boat.

In another advantageous feature of the present invention, the bait net casting device allows the user to hold the net with both hands without having to worry about it slipping away or falling off the boat. This allows the user to use full body motion and throw the net much farther and more accurately.

In another advantageous feature of the present invention, the bait net casting device can be deployed instantly to cast the net without having to worry about losing it in the process thereby reducing the time taken from spotting the sea species to catching them. The bait net casting device is foldable and allows for easy storage and transport.

Features and advantages of the invention hereof will become more apparent in light of the following detailed description of selected embodiments, as illustrated in the accompanying FIGS. As will be realised, the invention disclosed is capable of modifications in various respects, all without departing from the scope of the invention. Accordingly, the drawings and the description are to be regarded as illustrative in nature.

### BRIEF DESCRIPTION OF THE DRAWINGS

Further features and advantages of the present invention will become apparent from the following detailed description, taken in combination with the appended drawings, in which:

FIG. 1 illustrates an environment in which a bait net casting device is used to catch sea species, in accordance with one embodiment of the present invention;

FIG. 2 illustrate a perspective view of the bait net casting device;

FIGS. 3 and 4 illustrate a perspective view and a front view, respectively of a housing;

FIG. 5 illustrates a front view of cables connecting rings;

FIG. 6 illustrates the feature of a user drawing a belt to connect the bait net casting device; in accordance with one embodiment of the present invention;

FIG. 7 illustrates an operational view in which the user is throwing or casting the net, in accordance with one exemplary embodiment of the present invention; and

FIG. 8 illustrates an operational view in which the user is pulling the cord to grasp the net, in accordance with one exemplary embodiment of the present invention.

It will be noted that throughout the appended drawings, like features are identified by like reference numerals.

### DETAILED DESCRIPTION OF THE EMBODIMENTS

Before the present features and working principle of a bait net casting device is described, it is to be understood that this invention is not limited to the particular system as described, since it may vary within the specification indicated. Various features of a bait net casting device might be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present invention describes a bait net casting device for catching sea species. The bait net casting device includes a housing having a reel with a retractable tension cord. The housing includes an opening at the top and forms a handle for holding the bait net casting device when not in use. The bait net casting device includes line strands connecting the cord via connecting rings at one end and a disk at another end. The bait net casting device includes a line coupler drawn through the line strands. The line coupler travels along the length of the line strands. The bait net casting device includes a net connecting the disk. The net includes a lead line at its circumference. The lead line includes weights circumferentially spaced in relation to another. A user draws a belt through the opening to connect and suspend the housing from the belt. The net casts pulling the cord from the reel. Further, the cord retracts into the housing pulling back and closing the net.

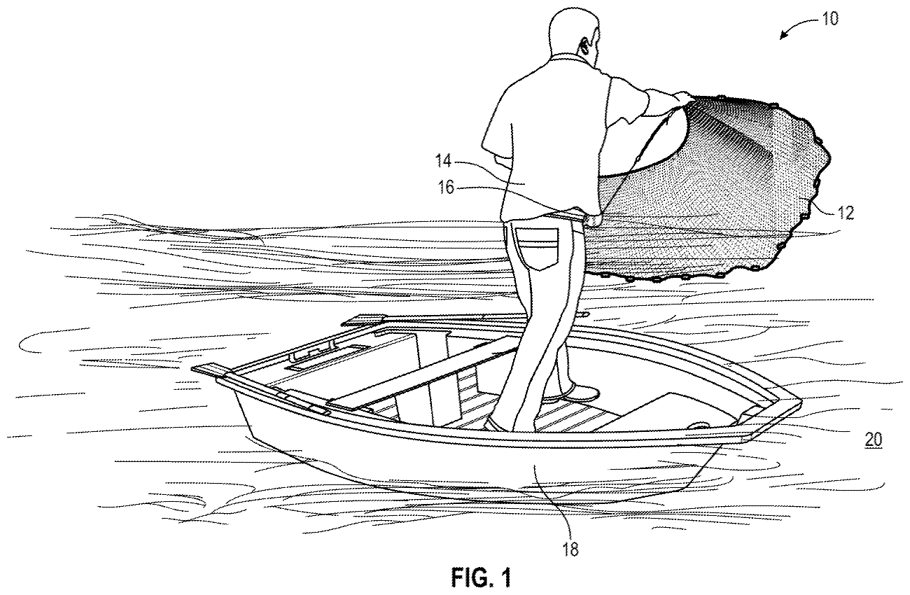

Various features and embodiments of the bait net casting device for catching sea species are explained in conjunction with the description of FIGS. 1-8.

The present invention discloses a bait net casting device for catching sea species. FIG. 1 shows an exemplary environment 10 in which bait net casting device 12 is used to catch sea species such as baitfish, shrimp, etc., in accordance with one embodiment of the present invention. A user 14 such as a fisherman connects bait net casting device 12 to his waist or belt 16 while standing on boat 18 in water 20. Although FIG. 1 shows user 16 standing on boat 18 and using bait net casting device 12, it is possible for user 16 to use bait net casting device 12 standing on a shore, or wading into a body of water 20 without departing from the scope of the present invention.

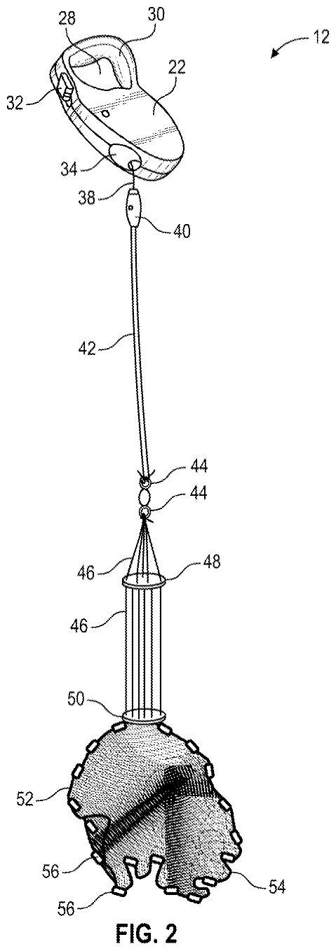

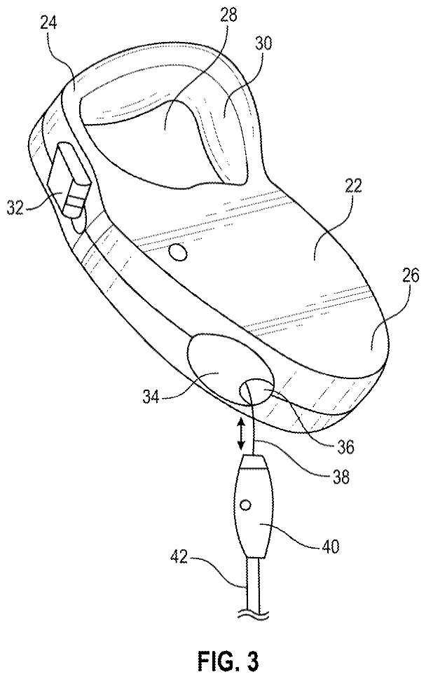

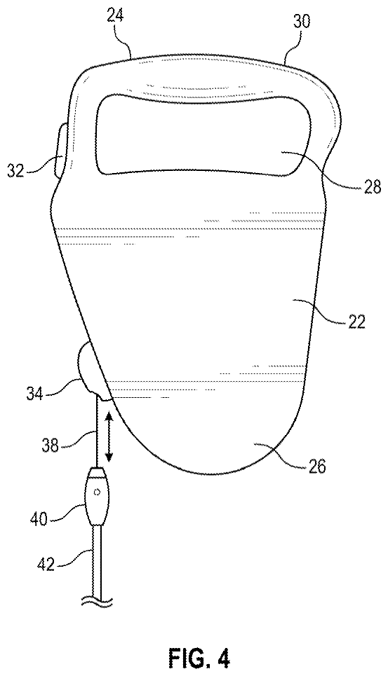

Referring to FIGS. 2, 3, 4, and 5, constructional features of bait net casting device 12 is explained. FIG. 2 shows a perspective view of bait net casting device 12, in accordance with one embodiment of the present invention. Bait net casting device 12 includes housing 22. Housing 22 comes in a variety of shapes including, but not limited to, oval, square, rectangular, conical or any other shape. Housing 22 provides a material made of hard plastic, wood, metal or any other suitable material. In one example, housing 22 presents a hollow structure and provides a lightweight configuration. Housing 22 has first end 24 and second end 26, as can be seen from FIGS. 3 and 4. Here, first end 24 indicates a top end and second end 26 indicates bottom end of housing 22. At first end 24, housing 22 encompasses opening 28. Opening 28 is formed in a variety of shapes and sizes depending on the need. First end 24 and opening 28 present handle 30 allowing user 14 to hold bait net casting device 12 when not in use.

Bait net casting device 12 presents actuator 32. In one embodiment, bait net casting device 12 provides extended section 34 extending from walls of housing 22, as shown in FIG. 4. In one example, extended section 34 is curved and presents a smooth surface. Extended section 34 presents hole 36 facing downwards i.e., towards second end 26 of housing 22. In the present embodiment, housing 22 encompasses retractable tension cord 38. Cord 38 provides a long slender flexible material made of twisted strands or fibers or any other similar material. In one exemplary embodiment, housing 22 encompasses a reel (not shown) that wounds cord 38. The reel encompasses a steel torsional spring that provides the force to retract cord 38. Here, the reel wounds/wraps cord 38 around it and shortens the length of cord 38. Further, upon exerting force, say by user 14, cord 38 relieves tension (from its coiled configuration around the reel) and extends its length. In one example, actuator 32 engages the reel to wound or unwound cord 38. Cord 38 extends from housing 22 through hole 40 and extended section 34 ensures smooth functioning i.e., extending and contracting in the vertical direction only with respect to housing 22.

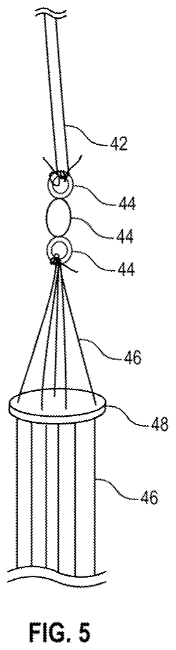

Further, cord 38 connects to connector 40. Connector 40 receives cord 38 at one end and connects to cables 42. In one example, cables 42 help to release or ease the tension formed on cord 38 during its use. Cables 42 connect to connecting rings or fastening means 44, as shown in FIG. 5. Connecting rings 44 connect to line strands 46. Line strands 46 draw through line coupler 48 and connect to disk or yoke or annular sleeve 50. A person skilled in the art understands that line coupler 48 draws through and travels along the length of line strands 46. Line coupler 48 helps to align net 52 in the direction of user casting bait net casting device 12. User 14 positions line coupler 48 along the length of line strands 46 depending on the need. In one example, line coupler 48 prevents disk 50 from coming in contact with cord 38 and/or cables 44 during use. This way, the tangling of cord 38, cables 44 and line strands 46 is avoided.

Disk 50 provides a material made of plastic or treated metal. Disk 50 is made of a durable material that is resistant to water-induced corrosion. Disk 50 comes in a flat or tubular configuration. Disk 50 includes apertures (not shown) for receiving net 52 using a variety of connecting mechanisms. In one example, the uppermost end of net 52 draws through the apertures at disk 50 and a knot is tied to secure net 52 to disk 50. Here, disk 50 locates centrally with respect to net 52 and serves as an attachment point for net 52. A person skilled in the art understands that net 52 releasably connects to disk 50. Net 52 comes with different mesh sizes depending on the need. For example, net 52 has a mesh size such as ¼ inch, ⅜ inch, ½ inch, and ⅝ inch to prevent escape of the captured sea species such as fish, shrimps, etc. Net 52 presents lead line 54. Lead line 54 indicates a rope that extends around the perimeter edge of net 52. Further, lead line 54 includes weights 56. Weights 56 come in a variety of shapes and sizes depending on the need. Weights 56 position at equal or varied distance from one another depending on the need. When bait net casting device 12 is thrown in water 20, weights 56 help to sink lead line 54 portion of net 52 faster than disk 50 portion of net 52. In one example, user 14 adjusts the weight and size of weights 56 at one side/edge of net 52 to sink net 52 faster at that side.

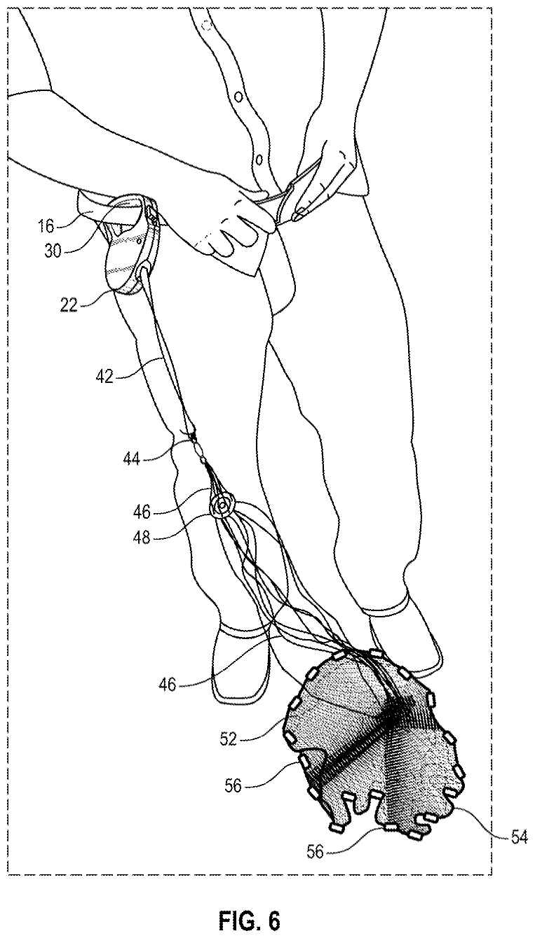

FIG. 6 shows the feature of user 14 connecting bait net casting device 12 to his waist or belt 16, in accordance with one exemplary embodiment of the present invention. Here, user 14 draws belt 16 through opening 28 of housing 22 and suspends bait net casting device 12 from his waist, for example. As bait net casting device 12 connects to the user's waist at all times, user 14 does not have to worry about losing bait net casting device 12 while wading in shallow water 20 or in boat 18.

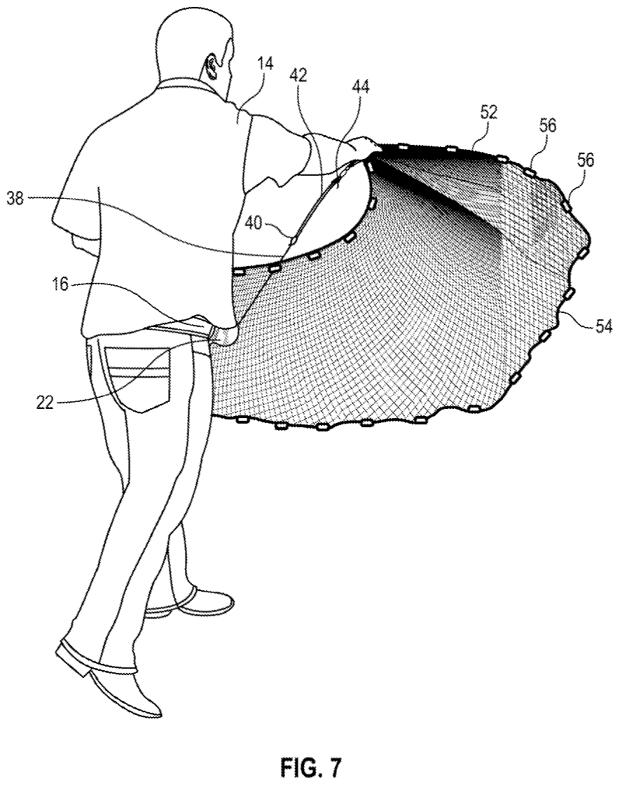

Now, referring to FIGS. 1, 7 and 8, the operation of bait net casting device 12 is explained, in accordance with one exemplary embodiment of the present invention. As specified above, user 14 stands on the shore, wades into the body of water 20 or stands on boat 18 for using bait net casting device 12. Here, user 14 connects housing 22 by drawing belt 16 through opening 28. This prevents bait net casting device 12 from falling into water 20. Subsequently, user 14 grasps net 52 along lead line 54 with one hand and holds disk 50 with other hand. User 14 then twists away from water 20 to generate momentum to throw net 52 into the water 20. Here, user 14 rotates in clockwise or anticlockwise direction such that the motion opens net 52 wide open in a plane just above and parallel to the surface of water 20 before falling into the water 20, as shown in FIGS. 1 and 7. Here, cord 38 extends from the reel and increases its length thereby allowing user 14 to throw net 52 at a distance from him/her.

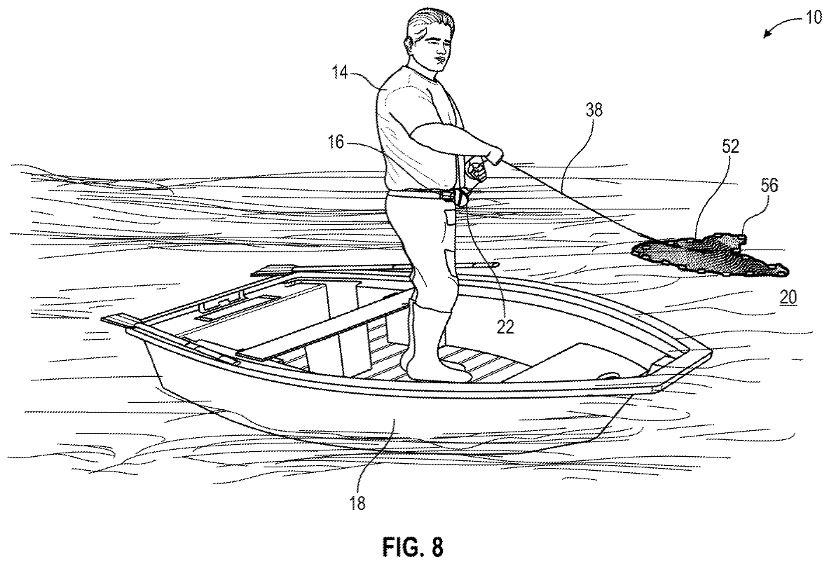

Upon throwing net 52, weights 56 force net 52 to fall through the water 20 until net 52 reaches desired depth. User 14 leaves net 52 in water 20 for desired time period to catch sea species such as fish, shrimps, etc. Once ready, user 14 pulls cord 38 towards him to harvest the sea species, as shown in FIG. 8. Pulling cord 38 causes cables 42, line strands 46, line coupler 48 and net 52 to follow. As user 14 pulls cord 38, net 52 and/or weights 56 close preventing the sea species from escaping net 52. User 14 pulls cord 38 until net 52 comes within his grasp. Once user 14 gets hold and lifts net 52, water escapes through the mesh while retaining the catch in net 52. User 14 opens up net 52 and places the sea species into a storage area such as a container, for example. After completion of catching the sea species, the reel causes cord 38 to retrieve into housing 22 where cord 38 wounds around the reel thereby bringing bait net casting device 12 to its default position, as shown in FIG. 6.

After use, user 14 removes belt 16 through opening 28 to separate housing 22. Subsequently, user 14 folds net 52, cables 42, and line strands 46 for easy storage and transport.

Based on the above, it is evident that the presently disclosed bait net casting device provides an opening to connect the housing having a retractable cord to the user's waist belt. The cord easily extends and retracts into the housing thereby allowing the user to operate with minimum space. The bait net casting device connects to the user around his waist and allows the user to use both hands to throw the net farther and more accurately. Further, the bait net casting device is free from tangling of ropes and provides an easy way to cast the net. The bait net casting device can be deployed instantly to cast the net without having to worry about losing it in the process thereby reducing the time taken from spotting the sea species to catching them.

A person skilled in the art appreciates that the bait net casting device may come in a variety of sizes depending on the need and comfort of the patient. Further, the user selects the size of the bait net casting device depending on the need. Further, different materials in addition to or instead of materials described herein may also be used and such implementations may be construed to be within the scope of the present invention. Further, many changes in the design and placement of components may take place without deviating from the scope of the presently disclosed bait net casting device.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A bait net casting device, comprising:
a housing comprising a reel with a retractable tension cord, wherein said housing comprises:
an opening;
a disk connecting said cord;
a net connecting said disk, wherein said net comprises a lead line at its circumference; and
weights circumferentially spaced in relation to another at said lead line,
wherein a belt at user's waist draws through said opening to connect and suspend said housing from said belt, wherein said net casts pulling said cord from said reel, and wherein said cord retracts into said housing pulling back and closing said net.

2. The bait net casting device of claim 1, further comprises line strands connecting said cord via connecting rings at one end and said disk at another end.

3. The bait net casting device of claim 1, further comprises cables connecting said cord via a connector.

4. The bait net casting device of claim 1, further comprises cables connecting said cord via a connector, wherein said cables connect to connecting rings, wherein said connecting rings connect to line strands, and wherein said line strands connect to said disk.

5. The bait net casting device of claim 4, further comprises a line coupler drawn through said line strands, wherein said line coupler travels along said line strands and aligns said net in the direction of said net when casted.

6. The bait net casting device of claim 1, wherein said disk comprises apertures for receiving said net.

7. The bait net casting device of claim 1, wherein said housing comprises an extended section having a hole, wherein said cord extends from said hole, and wherein said extended section ensures said cord extends and retracts in a vertical direction with respect to said housing.

8. The bait net casting device of claim 1, further comprises an actuator positioned at said housing for operating said reel.

9. The bait net casting device of claim 1, wherein the opening at the top of the housing forms a handle for holding the bait net casting device.

10. A bait net casting device, comprising:
a housing comprising a reel with a retractable cord, wherein said housing comprises an opening;
line strands connecting said cord via connecting rings at one end and a disk at another end;
a line coupler drawn through said line strands, wherein said line coupler travels along the length of line strands;
a net connecting said disk, wherein said net comprises a lead line at its circumference; and
weights circumferentially spaced in relation to another at said lead line,
wherein a belt at user's waist draws through said opening to connect and suspend said housing from said belt, wherein said net casts pulling said cord from said reel, and wherein said cord retracts into said housing pulling back and closing said net.

11. The bait net casting device of claim 10, further comprises cables connecting said cord via a connector, wherein said cables connect to said connecting rings.

12. The bait net casting device of claim 10, wherein said line coupler travels along said line strands and aligns said net in the direction of said net when casted.

13. The bait net casting device of claim 10, wherein said disk comprises apertures for receiving said net.

14. The bait net casting device of claim 10, wherein said housing comprises an extended section having a hole, wherein said cord extends from said hole, and wherein said extended section ensures said cord extends and retracts in a vertical direction with respect to said housing.

15. The bait net casting device of claim 10, further comprises an actuator positioned at said housing for operating said reel.

16. The bait net casting device of claim 10, wherein the opening at the top of the housing forms a handle for holding the bait net casting device.

17. A method of providing a bait net casting device, the method comprising steps of:
providing a housing comprising a reel with a retractable cord, said housing comprising an opening;
providing line strands connecting said cord via connecting rings at one end and a disk at another end;
providing a line coupler drawn through said line strands, said line coupler travelling along the length of line strands;
providing a net connecting said disk, said net comprising a lead line at its circumference;
providing weights circumferentially spaced in relation to another at said lead line;
drawing a belt at user's waist draws through said opening for connecting and suspending said housing from said belt;
casting said net thereby pulling said cord from said reel; and
retracting said cord into said housing pulling back and closing said net.

18. The method of claim 17, further comprising providing cables connecting said cord via a connector, said cables connecting said connecting rings.

19. The method of claim 17, further comprising providing apertures at said disk for receiving said net.

20. The method of claim 17, further comprising providing an extended section having a hole at said housing, said cord extending from said hole and said extended section ensuring said cord extends and retracts in a vertical direction with respect to said housing.
